(19) United States
(12) Patent Application Publication
(10) Pub. No.: US 2017/0090982 A1
(43) Pub. Date: Mar. 30, 2017

(54) DYNAMIC TASK SCHEDULER IN A MULTI-CORE ELECTRONIC CONTROL UNIT

(71) Applicants: Robert Bosch GmbH, Stuttgart (DE); Robert Bosch Engineering and Business Solutions Limited, Bangalore (IN)

(72) Inventors: Srijai Govindarajan, Coimbatore (IN); Mukunda Gopal, Tamilniaou Moggapair West (IN); Radhakanth Perumbedu Kosalaram, Chennai (IN)

(21) Appl. No.: 15/280,458

(22) Filed: Sep. 29, 2016

(30) Foreign Application Priority Data
Sep. 30, 2015 (IN) 5192/CHE/2015

(51) Int. Cl. G06F 9/48

(52) U.S. Cl. CPC G06F 9/4887

(57) ABSTRACT

A dynamic task scheduler in a multi core electronic control unit is provided. The electronic control unit comprises at least one primary core and at least one secondary core. The primary core executes a task based on output of the secondary core. The electronic control unit further comprises a counter for determining a task-execution time of the primary core and the secondary core. The task scheduler compares a task-execution time of the primary and secondary cores and optimizes the task-execution time of at least one of the primary core and the secondary core.

### CROSS REFERENCE

The present application claims the benefit under 35 U.S.C. §119 of India Patent Application 5192/CHE/2015 filed on Sep. 30, 2015, which is expressly incorporated herein by reference in its entirety.

### FIELD

This present invention relates to a dynamic task scheduler in a multi-core electronic control unit.

### BACKGROUND INFORMATION

Today's most of the electronic control units in a vehicle are single core with single OS (Operating System) System. The advent of multi-/many-core or multi-OS electronic control unit's demands an efficient use of transfer of the software designed for single core systems to multi-/many-core or multi-OS systems without losing the real-time behavior. For instance, a torque control algorithm runs on these electronic control units calculates the driver demand torque, coordinates various external interventions such as gear shift demands, demands information from the stability control, accessory control units and provides a set point for the operation of an engine or any other energy source thereof. Currently the multi-OS schedulers work on the principle of assigning tasks to available hardware resources such as processor cores or hardware threads and sharing a core among multiple applications.

A WIPO patent application 2010138031 describes a method and a scheduler in an operating system for scheduling processing resources on a multi-core chip which comprises a plurality of processor cores.

The method comprises allocating a plurality of processor cores to the application and increasing the frequency of the one processor core executing the application to the second frequency, such that the processing speed is increased more than predicted by Amdahl's law.

### BRIEF DESCRIPTION OF THE DRAWINGS

Different example embodiments of the present invention are described in detail below and are shown in the figures.

FIG. 1 illustrates a block diagram of an electronic control unit in an embedded system according to one embodiment of the present invention.

FIG. 2 illustrates a flowchart of a method of optimizing a task-execution time of at least one task according to the present invention.

### DETAILED DESCRIPTION OF EXAMPLE EMBODIMENTS

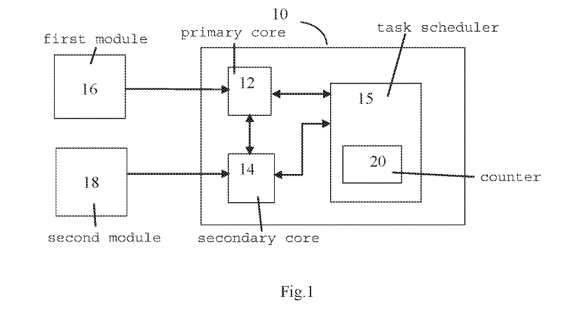

FIG. 1 illustrates a dynamic task scheduler 15 in a multi core electronic control unit 10 according to one embodiment of the present invention. The electronic control unit 10 comprises at least one primary core 12 and at least one secondary core 14. The primary core 12 executes a task based on output of the secondary core 14. The electronic control unit 10 further comprises a counter for determining a task-execution time of the primary core and the secondary core 14. The task scheduler 15 compares a task-execution time of the primary core 12 and secondary core 14 and optimizes the task-execution time of at least one of the primary core 12 and the secondary core 14.

Each core executes a set of tasks which are predefined during calibration process. For instance, the electronic control unit 10 is a vehicular control unit, and it comprises a primary core 12 and a secondary core 14 which receives tasks from an engine and a speed sensor respectively. The tasks coming from the engine will be constantly executed by the primary core 12 and the tasks coming from the speed sensor will be constantly executed by the secondary core 14. The tasks will be interdependent like in a client-server mechanism. When one task in primary core 12 is executed, the data in the task is stored temporarily in a cache memory. Since, the two tasks are interdependent, the secondary core 14 uses the data of the first task and executes the second task. The task-execution time is the time taken for at least one core to execute the task. The counter 20 determines the task-execution time by counting the number of times the received task is executed. The electronic control unit 10 aborts or stops the execution of the at least one task upon detecting of the execution of the same data for more than a predefined number of times. For instance, the task scheduler 15 present in the electronic control unit 10 aborts the execution of the second task of the secondary core (if the second task is dependent on the first task), if the same data is executed for more than 3 times.

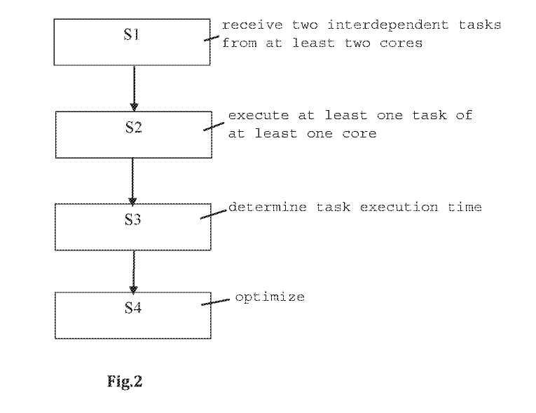

FIG. 2 illustrates a dynamic task scheduling method for a multi-core electronic control unit 10 according to the invention. In step S1 at least two interdependent tasks from at least two cores 12, 14 are received. In step S2 at least one received task of at least one core 14 is executed, in dependence with an output of another executed task at another core 12. The task execution times of said cores 12, 14 are determined in step S3. In step S4, the task execution time of at least one core 12, 14 is optimized.

The above passage is explained in detail below. The electronic control unit 10 comprising at least one primary core 12 and at least one secondary core 14 receives at least two interdependent requests from at least two modules 16, 18. Each core 12, 14 executes received task in different instant of times for every predefined time intervals respectively. For example, the primary core 12 will execute the received task from the first module 16 for every 1 sec and the secondary core 14 will execute the received task from the second module 18 for every 200 msec. The primary core 12 executes the received task based on the output of the secondary core 18. The counter 20 present in the electronic control unit 10 increments a number for every execution of each task. The counter 20 counts the number of times either the first task or the second task is executed. The task scheduler 15 of the electronic control unit 10 optimizes the task-execution time of at least one received task by increasing or decreasing the task-execution time, if the number of execution times of at least one received task counted by the counter 20 is more than a predefined value.

The above method is disclosed with an example below:

Let the electronic control unit 10 comprises a primary core 12 and a secondary core 14 which executes a first task and a second task respectively, received from a first module 16 and a second module 18. The second task is dependent on the first task. Let the primary core 12 executes the first task for every 1 sec, the secondary core 14 executes the second task for every 200 msec. Since, the second task is dependent on the first task, the second task will be executed for another 4 times before the second time of the execution of the first task, i.e., for every 200 msec, and also the second task comprising the same data will be executed. The data getting executed in the second task will be stored in a cache memory. The first task while getting executed by the primary core 12 uses the output of the second task stored in the cache memory. The counter 20 determines the task-execution time of the second task and the counter 20 increments by a number for every execution of the second task. The task scheduler 15 of the electronic control 10 optimizes the task-execution time of either the first task or the second task or the both, if the determined number of task-execution times of the second task determined by the counter 20, is more than or equal to the predefined value, e.g., to 3, then the electronic control unit 10 optimizes the task-execution time of the cores by increasing or decreasing. The task scheduler 15 of the electronic control unit 10 either reduces the execution time of the first task to 500 msec or increases the execution time of the second task to 500 msec or the both. When it is not possible to optimize the task-execution time of the core, the electronic control unit 10 aborts the execution of the second task if the same data is executed in the consecutive execution cycles.

In another case, if the first task is dependent on the second task. Let the first task will be executed for every 1 sec and the second task will be executed for every 6 sec. Upon receiving the first task and the second task, the primary core 12 and the secondary core 14 executes the first and the second task for every predefined time intervals, i.e., the second core 14 executes the second task for every 6 sec independence with the output of the first task from the primary core 12. The counter 20 determines the task-execution time of the first task and the electronic control unit 10 optimizes the task-execution time of the first task or the second task either by reducing the second task execution time to 4 sec or by increasing the first task execution time to 3 sec or the both. The electronic control unit 10 aborts the execution of the first task if the same data is executed in consecutive execution cycles.

In an embodiment, the electronic control unit 10 having a single core will receive at least two interdependent tasks from at least two modules. The electronic control unit determines a time required to execute each received task. Since, the two tasks are interdependent (i.e., only after the execution of at first task and depending on the output of the executed task, the core executes the second task), the counter present in the electronic control unit determines the task-execution time of either the first task or the second task or the both. The electronic control unit optimizes the task-execution time of at least one received task if the determined task-execution time is more than or equal to the predefined value.

With the above electronic control unit 10 and the method disclosed above, the electronic control unit 10 optimizes the task-execution time by scheduling the tasks in a real time. The electronic control unit 10 run time can be improved based on the current loading. Dynamic scheduling is allowed by increasing or decreasing the task-execution time of at least one received task.

The embodiments explained herein and the examples provided in the above detailed description in only illustrative and does not limit the scope of the present invention. Many modification and changes in the embodiments aforementioned are envisaged and are within the scope of the present invention.

What is claimed is:

1. A dynamic task scheduler in a multi core electronic control unit, the electronic control unit comprising:
at least one primary core and at least one secondary core, the primary core to execute a task based on output of said secondary core; and
a counter for determining a task-execution time of said primary core and said secondary core;
wherein the dynamic task scheduler is designed to compare a task-execution time of said primary and secondary cores and optimize the task-execution time of at least one of the primary core and the secondary core.

2. The dynamic task scheduler as recited in claim 1, wherein the dynamic task scheduler is designed to either increase or decrease the task-execution time of the primary and secondary cores to optimize run time of said electronic control unit.

3. The dynamic task scheduler as recited in claim 1, wherein the task scheduler is designed to abort the execution of said at least one task upon detection of execution of same data in consecutive execution cycles.

4. The dynamic task scheduler as recited in claim 2, wherein the run time of the electronic control unit is reduced by aborting said execution of said at least one task.

5. The dynamic task scheduler as recited in claim 1, wherein the task-execution time is a time taken to execute at least one task.

6. The dynamic task scheduler as recited in claim 1, wherein the task scheduler is designed to optimize the task-execution time of at least one task if a number of execution times of said at least one task is more than or equal to a predefined value.

7. A dynamic task scheduling method for a multi-core electronic control unit, said method comprising:
receiving at least two interdependent tasks from at least two cores;
executing at least one received task of at least one core in dependence with an output of an another executed task at another core;
determining task execution times of the cores; and
optimizing the task execution time of at least one core.

8. The method as recited in claim 7, the method further comprising:
aborting the execution of said at least one received task if the same data is executed in consecutive execution cycles.
